(19) United States
(12) Patent Application Publication
(10) Pub. No.: US 2022/0091604 A1
(43) Pub. Date: Mar. 24, 2022

(54) IPIZED DEVICE FOR UAV FLIGHT CONTROLLER

(71) Applicant: MiTAC Information Technology Corporation, Taipei City (TW)

(72) Inventor: HUNG-MAO CHU, Taipei City (TW)

(21) Appl. No.: 17/316,753

(22) Filed: May 11, 2021

(30) Foreign Application Priority Data
Sep. 22, 2020 (TW) 109132700

(51) Int. Cl. G05D 1/00; B64D 45/00

(52) U.S. Cl. CPC G05D 1/0016; H04L 67/12; B64D 45/00; G05D 1/0022

(57) ABSTRACT

An IPized device for UAV flight controller includes a flight control transmission and control interface module connected to the UAV flight controller for capturing flight control data message of the UAV flight controller. An IPized device module uses an IP address to control and transmit data to the UAV, to convert the flight control data message into a packet format message of the Ethernet, and then to use a data transmission module to transmit the packet form message to the local network or the Internet. The IPized device module is used to receive a control message packet of the local area network or the Internet, and to convert the control message packet into a flight control message of the communication protocol of the UAV flight controller. The flight control message is then transmitted to the UAV flight controller through the flight control transmission and control interface module.

### CROSS REFERENCE TO RELATED APPLICATION

This application claims the benefits of Taiwan application Serial No. 109132700, filed on Sep. 22, 2020, the disclosures of which are incorporated by reference herein in its entirety.

### TECHNICAL FIELD

The present disclosure relates in general to a flight controller of an unmanned aerial vehicle (UAV), and more particularly to an IPized device for UAV flight controller.

### BACKGROUND

Commercial unmanned aerial vehicles (UAV) are different from general consumer unmanned aerial vehicles. Commercial unmanned aerial vehicles have high reliability, which can be customized according to the demands of users and utilized in varied fields. In order to improve the flexibility of commercial unmanned aerial vehicles, each manufacturer designs their products and equipment in a way of modularization. Through modular design, commercial unmanned aerial vehicles can be customized and employed for specific and varied applications.

At present, commercial unmanned aerial vehicles mainly communicate and exchange data with a ground control station via radio. However, in addition to the limitation of radio range, it is difficult to implement flexible applications and integrations through radio communications.

Each unit of the commercial unmanned aerial vehicle is a modular design. New modules can be developed or existing modules can be modified according to the demands of users. Among the modules, the flight controller is the core of the unmanned aerial vehicle, responsible for controlling the flight missions and flight stability of the unmanned aerial vehicle. The flight controller mainly utilizes UART (Universal Asynchronous Receiver/Transmitter) IC chip and dedicated communication protocols to communicate and exchange data and messages with the ground control station through a radio transceiver module. However, besides the limitation of radio range, it is also difficult to apply and integrate flexibly. In order to improve the control quality and flexible application of commercial unmanned aerial vehicles, there is an urgent need of an IPized device for commercial unmanned aerial vehicles in the future. With the proposed IPized device, UAVs can be controlled via a local area network or the Internet. Besides, the IPized device can be integrated with other modules to realize the communication between a commercial UAV and a ground control station through an IP network.

### SUMMARY

An object of the present disclosure is to provide an IPized device for UAV flight controller that can utilize an IP network to carry out communication between a commercial UAV and a ground control station. Thereupon, the issue of limitation of radio range can be eliminated, the communication quality can be ensured through the communication protocols, and the integration with other modules can be more flexible.

In this disclosure, the IPized device for UAV flight controller includes a flight control transmission and control interface module and an IPized device module. The flight control transmission and control interface module, connected with a flight controller of a UAV, is configured for capture a flight control data message from the flight controller. The IPized device module is configured for utilizing an IP address to perform control and data transmission with respect to the UAV, converting the flight control data message into a corresponding packet format message of an Ethernet, and then utilizing a data transmission module to upload the packet format message to a local network or an Internet. When a control message packet in the local network or the Internet is received, the IPized device module would convert the control message packet into a corresponding flight control message for a communication protocol of the flight controller of the UAV, and then the flight control transmission and control interface module is applied to transmit the flight control message to the flight controller.

By providing the IPized device for UAV flight controller of this disclosure, following advantages can be obtained.

1. The IPized device can convert the communication protocol of the flight controller between the local network and the Internet, and use the IP address to process control and data transmission upon the UAV. Thereupon, the application of the UAV can be flexible, and the volume thereof can be smaller, the installation thereof can be simple. In addition, the energy consumption thereof can be less, and the flight controller thereof can be completely integrated.

2. The IPized device of this disclosure can be energized by the flight controller or an external power source.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic block view of an embodiment of the IPized device for UAV flight controller in accordance with this disclosure;

FIG. 2 demonstrates schematically steps performed by the UAV flight controller for converting a flight control data message into a packet format message in accordance with this disclosure; and

FIG. 3 demonstrates schematically steps for converting a control message packet into a flight control message of a communication protocol of the flight controller in accordance with this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In accordance with this disclosure, an IPized device for UAV flight controller is to perform UAV flight control though a local network (LAN) or the Internet, and can integrate other modules to communicate through communication protocols of the Internet (IP).

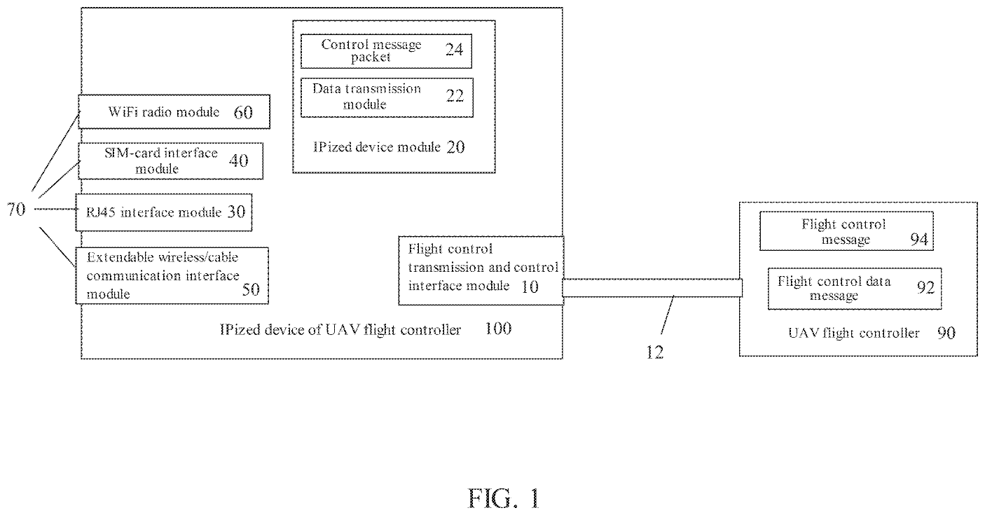

Referring to FIG. 1, a schematic block view of an embodiment of the IPized device for UAV flight controller in accordance with this disclosure is shown. In this embodiment, the IPized device for UAV flight controller 100 includes a flight control transmission and control interface module 10 and an IPized device module 20. The IPized device for UAV flight controller 100 utilizes the flight control transmission and control interface module 10 to connect a UAV flight controller 90 via a connection wire 12. The IPized device 100 is energized by the UAV flight controller 90, or, in another embodiment not shown here, by an external power source. The flight control transmission and control interface module 10 is configured to capture a flight control data message 92 from the UAV flight controller 90. The flight control data message 92 includes all the state and control information of the UAV having at least a flight attitude, a flight interior orientation, a flight exterior orientation, GPS information, a flight height and sensor-detected data.

The IPized device module 20 utilizes an IP address to perform control and data transmission with respect to the UAV, and is configured to convert the flight control data message 92 into a corresponding packet format message 22 for an Ethernet. Then, a data transmission module 70 is applied to upload the packet format message 22 to the local network or the Internet. In this embodiment, the data transmission module 70 can be an RJ45 interface module 30, a SIM (Subscriber identity module) card interface module 40, an extendable wireless/cable communication interface module 50 or a WiFi radio module 60.

The RJ45 interface module 30 can connect a network communication device through the Internet to carry out data transmission. The SIM-card interface module 40 can receive a SIM card to transmit data via a global system for mobile communications. The extendable wireless/cable communication interface module 50 can connect any extendable network communication device to transmit data. In addition, the WiFi radio module 60 utilizes the WiFi to connect a network communication device for performing the data transmission.

After the flight control transmission and control interface module 10 is connected with the UAV flight controller 90, the IPized device for UAV flight controller 100 would analyze the communication protocol of the UAV flight controller 90 so as to establish an information cascade, so that the flight control transmission and control interface module 10 can capture raw data from the UAV flight controller 90. Then, the IPized device module 20 would convert the flight control data message 92 into a corresponding packet format message 22, and the packet format message 22 is further forwarded to at least one ground control station via the RJ45 interface module 30, the SIM-card interface module 40, the extendable wireless/cable communication interface module 50 or the WiFi radio module 60 through the local network or the Internet.

As the IPized device module 20 receives a control message packet 24 from the ground control station transmitted via the RJ45 interface module 30, the SIM-card interface module 40, the extendable wireless/cable communication interface module 50 or the WiFi radio module 60 through the local network or the Internet, the control message packet 24 would be converted into a corresponding flight control message 94 for the communication protocol of the UAV flight controller. Further, the flight control transmission and control interface module 10 would forward the flight control message 94 to the UAV flight controller 90.

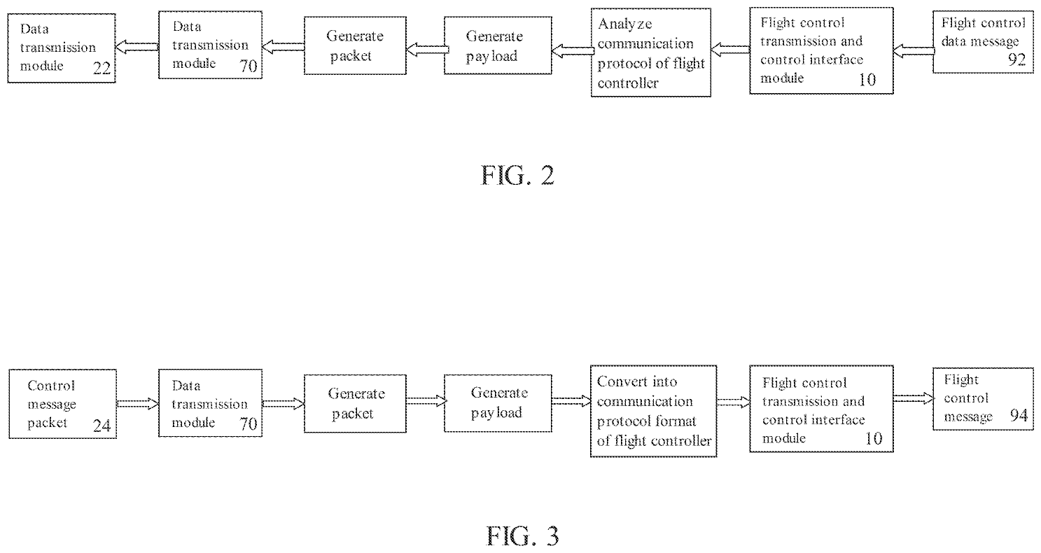

FIG. 2 demonstrates schematically steps performed by the UAV flight controller for converting the flight control data message into the packet format message in accordance with this disclosure. As shown, the IPized device 20 converts the UAV flight control data message 92 into an Ethernet packet (i.e., a data packet) format. According to the communication protocol of the flight controller 10, the IPized device 20 would realize the flight control data message 92 of the flight controller 10, and then the flight control data message 92 would be converted into a corresponding IP packet format message 22 according to the IP protocol. Generally, a packet includes control information (i.e., a header) and an information body (i.e., a payload). Finally, the IP packet format message 22 is uploaded to the local network or the Internet through a transmission control protocol (TCP) or a user datagram protocol (UDP).

FIG. 3 demonstrates schematically steps for converting the control message packet into a corresponding flight control message of a communication protocol of the flight controller in accordance with this disclosure. As shown, the IPized device would convert the flight control message of the UAV from the local network or the Internet. The IPized device would convert the control message packet 24 in the Ethernet packet format into a corresponding flight control message 94 for the communication protocol of the flight controller 10. The IPized device would realize the packet and the associated payload in the packet as well, and then the flight control message 94 in the data format complying with the communication protocol of the flight controller would be forwarded to the flight controller 10.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An IPized device for UAV flight controller, comprising:
a flight control transmission and control interface module, connected with a flight controller of a UAV, configured for capture a flight control data message from the flight controller; and
an IPized device module, configured for utilizing an IP address to perform control and data transmission with respect to the UAV, converting the flight control data message into a corresponding packet format message of an Ethernet, and then utilizing a data transmission module to upload the packet format message to a local network or an Internet;
wherein, when a control message packet in the local network or the Internet is received, the IPized device module would convert the control message packet into a corresponding flight control message for a communication protocol of the flight controller of the UAV, and then the flight control transmission and control interface module is applied to transmit the flight control message to the flight controller.

2. The IPized device for UAV flight controller of claim 1, wherein the data transmission module is one of an RJ45 interface module, a SIM-card interface module, an extendable wireless/cable communication interface module and a WiFi radio module.

3. The IPized device for UAV flight controller of claim 1, wherein the flight control data message includes state and control messages of the UAV having at least a flight attitude, a flight interior orientation, a flight exterior orientation, GPS information and a flight height.

4. The IPized device for UAV flight controller of claim 1, wherein the IPized device is energized by the flight controller or the UAV or an external power source.
